(19) United States
(12) Patent Application Publication
(10) Pub. No.: US 2006/0274545 A1
(43) Pub. Date: Dec. 7, 2006

(54) Tail light source attitude adjusting assembly

(76) Inventors: Filip Rosenstein, Stuttgart (DE); Bernd Mack, Remshalden (DE)

Correspondence Address: CLARK HILL, P.C., 500 WOODWARD AVENUE, SUITE 3500, DETROIT, MI, 48226, US

(21) Appl. No.: 11/448,301

(22) Filed: Jun. 7, 2006

(30) Foreign Application Priority Data
Jun. 7, 2005 (DE) DE 102005027185.5

(51) Int. Cl. F21V 17/02

(52) U.S. Cl. 362/512

(57) ABSTRACT

A light intensity adjusting assembly for a light source of a motor vehicle. The light intensity adjusting assembly including a processor for processing electrical signals. The light intensity adjusting assembly also includes a first sensor for detecting a first ambient condition. The first sensor creates a first sensor signal to be transmitted to the processor. A second sensor detects a second ambient condition and creates a second sensor signal to be transmitted to the processor. The processor controls the light intensity of the light source based on the first and second sensor signals.

### BACKGROUND ART

1. Field of the Invention

The invention relates to a device for adjusting the light intensity of a light source. More particularly, the invention relates to a light source of a motor vehicle with a device for adjusting the light intensity of a light source based on an environmental condition

2. Description of the Related Art

In the motor vehicle field it is a known practice to detect the degree of contamination of a tail light cover with sensors. According to the degree of contamination, the sensor supplies a signal which is evaluated by an evaluation unit and is used to control the light source behind the light cover. The greater the degree of contamination, the higher the light intensity of the light source is set. Precisely, in motor vehicles is it important that the tail light can reliably be seen clearly under all conditions by other motorists.

### SUMMARY OF THE INVENTION

A light intensity adjusting assembly for a light source of a motor vehicle. The light intensity adjusting assembly including a processor for processing electrical signals. The light intensity adjusting assembly also includes a first sensor for detecting a first ambient condition. The first sensor creates a first sensor signal to be transmitted to the processor. A second sensor detects a second ambient condition and creates a second sensor signal to be transmitted to the processor. The processor controls the light intensity of the light source based on the first and second sensor signals.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a block diagram detailing the functionality of a device according to the invention; and

FIG. 2 is a schematic representation of a functional cycle of the device according to the invention, realized in software.

### DETAILED DESCRIPTION OF THE PREFERRED EMBODIMENT

In the following, the device will be described considering as an example the control of a tail light of an automobile. However, the device can generally be used there where it happens that a light source, as independently of environmental conditions as possible, produces a uniform brightness or is adjusted so that it is always clearly visible. Examples of this are traffic lights, which with the device can be controlled so that they can achieve an approximately constant visibility under the most varied of environmental factors.

With tail lights of motor vehicles, their visibility can be affected by the most varied of influences. Thus, dirt can be found on the outer side of a tail light cover which diminishes the brightness of the light. The recognizability of the tail light can, however, also be affected by direct sunlight on the tail light, by fog, by rain or, for example, by the varied light conditions by day and by night. With the device, it is possible to control the tail lights so that an advantageously consistent visibility under the most varied environmental influences is ensured. Thus the tail light can be controlled, for example, so that glare is avoided for following motorists in case of good conditions of visibility or the tail light can be well recognized by following motorists under poor conditions of visibility. According to the visibility conditions, it is sufficient to control the tail light so that it is clearly visible. In so doing, the light intensity can be completely different.

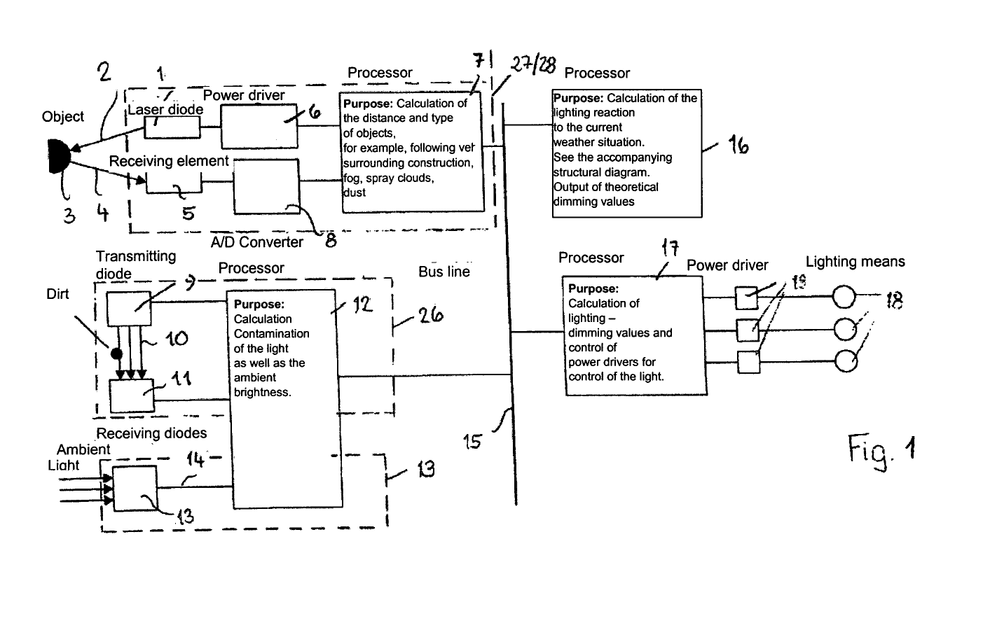

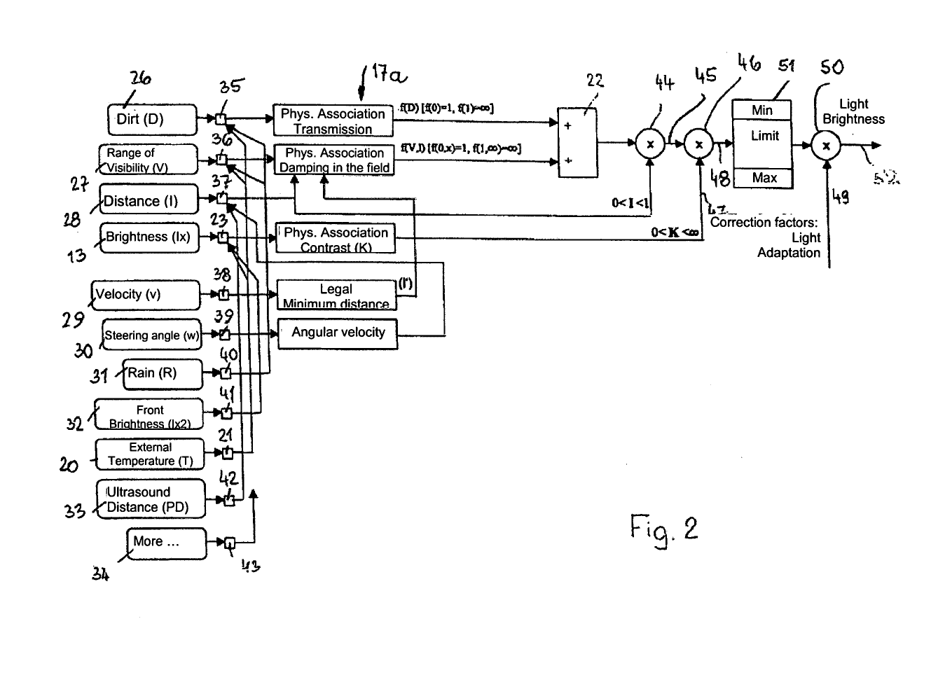

With the device it is possible to determine, for example, objects, dirt on the tail light cover, and ambient light of the motor vehicle. FIG. 1 shows, for example, a device with three sensors 13, 26, and 27/28. They are described as representatives of the sensors given in FIG. 2 for the most varied influencing factors. The sensor 13 serves to detect the brightness, the sensor 26 serves to detect dirt, and the sensor 27/28 serves to detect the range of visibility (27) or the distance I (sensor 28).

The sensor 27/28 has at least one transmission unit 1, which is a laser diode in the embodiment example. It emits a laser beam 2 which is reflected on the object to be detected 3. The reflected beam 4 reaches at least one receiving element 5 on the device. The objects 3 can be partially or completely reflecting objects like dust particles or water particles in the air, fixed objects like a curb on the street, trees, hedges and the like. The transmitting element 1 is connected to a power driver 6. It is in turn connected to a microprocessor 7. It controls the power driver 6.

The received reflected rays 4 received by the receiving element 5 are fed as analog signals in the form of voltage signals to an analog-digital converter 8, which produces corresponding digital signals which are fed to the processor 7.

With the processor 7, the distance of objects 3 and the type of objects can be calculated. Thus, the microprocessor 7 is in the position to recognize, for example, whether the acquired object 3 is a following automobile, an environmental construction, fog, spray clouds, or dust in the ambient air.

The sensor 26 has at least one transmitting element 9, preferably a transmitting diode whose rays 10 are directed against the tail light cover. They are reflected on the outer side of the light cover to at least one receiving element 11, which is preferably a receiving diode. If there are dirt particles on the exterior side of the light cover, the rays 10 are reflected at them to the receiving element 11. The more dirt particles are present, the more rays 10 are reflected to the receiving element 11.

If rain drops are found on the outer side of the light cover, then the rays 10 are deflected through them to the outside so that the receiving element 11 sitting behind the light cover receives fewer rays.

In the configuration described, the inner side of the light cover is essentially flat in the area of measurement of transmitting element 9 and receiving element 11.

The light cover can also have an indentation in the area of measurement, where transmitting element 9 and receiving element 11 lie closely opposite one another. The rays 10 proceeding from the transmitting element 9 pass in the edge area the indentation through the light cover first to the outside and at the opposite edge area once again through the light cover inwards to the receiving element 11. If dirt particles are found on the outer side of the indentation, then the rays 10 are deflected to the outside so that the receiving element 11 receives fewer rays.

It is also possible to provide the transmitting element 9 itself with a measurement surface which is located on the outer side of the tail light or even in the outer side of the tail light cover. On the measurement surface dirt settles in the same manner as on the outer side of the light cover. The degree of contamination of the measurement surface of the transmitting element 9 is assumed in the evaluation to be comparable to the degree of contamination of the outer side of the tail light cover.

The transmitting element 9 is controlled by a microprocessor 12. The receiving element 11 is also connected to the microprocessor 12. The receiving element 11 accordingly conducts the rays 10 reflected at the dirt particles to the microprocessor 12, which evaluates them to calculate the amount of dirt.

The sensor 13 has at least one microprocessor 12 that detects the ambient light, and supplies a signal 14 corresponding to the brightness of this ambient light to the microprocessor 12. It evaluates, taking into account this signal 14, the signals supplied by the receiving element 11 to characterize the degree of contamination.

The two processors 7 and 12 are connected to a bus line 15 via which the results evaluated by the processors 7, 12 are conducted further in the form of a signal. Additional processors can be connected to the bus line 15 without further effort. Thus, measurement data from the processors 7, 12 can be submitted to the evaluation processor 16. It is also possible that additional sensors 13, 20, 26 to 34 (FIG. 2) transmit data via the same bus line 15 to an evaluation processor 16 and thus can be located at any position in the vehicle. Furthermore, several processors, represented by way of example the processors 7, 12, 16, and 17, can be combined physically in one operating element.

The evaluation unit 16 is connected to the bus line 15, which calculates the illumination reaction to the current weather situation based on the signals supplied. In addition, a processor 17 is connected to the bus line 15 and serves to control illumination. The processor 17 evaluates the positioning variables produced by the evaluation processor 16 and produces from this the control signals for dimming the individual light chambers.

The evaluation processor 16 and the processors 7, 12, and 17 may, however, also be formed by a complex analog controller or digital logic. Digital controllers, positioning elements, filters, or digital circuit technology can also be used for evaluation. With the device, all the lighting means of a tail light can be controlled, including, but not limited to, the turn signal lights, the rear light, the brake light, the fog light, and the reflector light. Obviously, it is possible that not all, but rather only several or even only one of the lights 18 is controlled.

The microprocessor 16 calculates the illumination reaction taking into account the current weather situation. This will be described in more detail.

The microprocessor 17 produces light-dimming values and controls, via power drivers 19, for the lights 18. Each light 18 is advantageously assigned a corresponding power driver 19. The evaluation processor 16 evaluates the signals produced by the processors 7, 12 so that the light intensity of the lights 18 is optimal taking into account the particular conditions.

With the control device the most varied parameters can be detected and evaluated in order to adapt the brightness of the lights 18 of the tail light accordingly. FIG. 2 shows an assembly of the corresponding parameters and employed sensors. As has been explained with the aid of FIG. 1, the contamination 26 of the tail light cover or the measurement surface of the transmitting element 9 can be detected. Thereby the light transmitted through the tail light cover is determined. The contamination D detected by a measurement of transmitted light is directly correlated with the necessary increase of the light intensity via an exponential function.

The range of values of the contamination D in the schema represented (FIG. 2) ranges from 0 (for a clean light cover) to 1 (for a maximally contaminated, not transparent light cover). In the case of a clean light cover, no adaptation is necessary, f(D=0)=1. In the case of a maximally contaminated light cover, no further compensation is to be achieved with a finite increase of the light intensity, f(D=1)=∞. That means that there must be maximum subsequent control.

Furthermore, with the device, one can take into account the range of visibility V which is a measure for the damping in the field of measurement. The range of visibility V can be determined according to the Lambert-Beer law:
I=Iₒe^{αd}

where:

$$α = \frac{3}{MOR} ,$$

d=distance, I=intensity, I₀=intensity at distance d, I/I₀=transmission, and α can be determined by the meteorological range of visibility.

The extreme values are to be understood in the following way:
f(V=0,L=x)=1.

If no damping (reciprocal value of transmission) occurs. Then there must be no control upwards, independently of the distance to a following object. For f(V=1, L=∞)=∞ there is maximum fog and the following observer is at a maximum distance. In this case there must be maximum subsequent control.

Furthermore, with the device the distance I to the respective measured object 3 can be detected. The distance I can be measured simply and reliably by corresponding sensors 28 with which distances can be measured. Since the distance I correlates with the range of visibility V, both measured values are taken into account in the determination of the damping in the field of measurement.

The brightness Iₓ is a measure for the contrast K and is detected with the brightness sensor 13. In addition, measurement data already available in the vehicle are read in via the bus system 15. From the device the velocity v of the motor vehicle is also read in. From this, the legal minimum distance I′ can be determined.

This measured value I′ is also taken into account in the determination of the damping in the field of measurement. From the velocity, among other things, the legal minimum distance I′ can also be calculated. It can be used as an alternative value (replacement value) for the plausibility and the like of the distance I.

Furthermore, with the device, the steering angle of the steering of the motor vehicle can be read in. Corresponding sensors 30 which detect the steering angle are known and are also not described in more detail. With such sensors 30, in particular, the angular velocity in the steering process can be detected. The correspondingly determined signal is taken into account in the determination of the distance I in a manner still to be determined.

By means of a rain sensor 31, which customarily is a part of the equipment of a high-end vehicle, rain can also be detected. Rain sensors are also known and are also not described in more detail. The signal produced by the rain sensor 31 is taken into account in the determination of the transmission of the tail light cover.

Furthermore, with the device the front brightness I×2 can be detected. For this, a corresponding brightness sensor 32 is used. The signal produced by sensor is linked to the signal of the brightness sensor 13 in order to determine and control the contrast of the tail light.

With the temperature sensor 20, one determines in the described manner, among other things, the external temperature T whose signal is linked in the described manner to the signal of the brightness sensor 13. In addition, the signal of the temperature sensor 20 is linked to the output signal of the dirt sensor 26.

With an additional sensor 33, the distance to the objects 3 is measured by means of ultrasound. The signal produced by this sensor 33 is linked to the signal of the sensor 28 detecting distance I in the evaluation.

Furthermore, still another or alternative, measured value inputs are conceivable for the operation of the device, which is indicated in FIG. 2 by the sensor 34 and which are already installed in the vehicle for other purposes or are integrated especially for this task. Here, for example, technologies such as radar or image processing are conceivable above all.

The sensors 20, 29 to 33, and possibly the sensor 34 are preferably already a part of the vehicle and are used for other functions.

The measured data are available on a bus system of the vehicle to fulfill the sensors' function according to specifications, e. g., the velocity in an ABS system. These data are read in by the evaluation unit 16 and used to improve the model.

FIG. 2 represents the flow chart of the evaluation processor 16. 17a represents several structural elements in which the physical connection to the transmission, the damping in the field, the contrast, and the like are realized in the form of software, control algorithms, and so on.

13, 20, and 26 to 34 represent the input signals transmitted via the bus interface.

The flow diagram according to FIG. 2 shows the links of the various state variables which are measured by the respective sensors. The signals of the dirt sensor 26 are checked for plausibility with the signals of the temperature sensor 20 and the control sensor 31. Temperature and rain are, for example, used to distinguish between dirt/rain drops/snow/ice on the dirt sensor 26 since for different situations different reactions are required, which can be distinguished only poorly with a dirt sensor alone. The state variables detected by the three sensors, contamination D, external temperature T, and rain R determine the degree of transmission of the light transmitted by the tail light. The greater the degree of contamination D and the stronger the rain is, the brighter the tail light must shine.

The signals of the rain sensor 31 are furthermore linked with the signals of the range of visibility sensor 27. Also, the measured values of the external temperature sensor 20 are linked with the measured values of the range of visibility sensor 27. The output signal determined from these linked signals is evaluated in the processor 17 to determine the damping in the field of measurement. To take into account the damping in the field of measurement the measured values of the distance sensor 28 and of the velocity sensor 29 are drawn upon in addition.

The measured data of the distance sensor 28 are linked to the measured values of the distance sensor 33 and the steering angle sensor 30.

The measured values of the brightness sensor 13 are linked with the measured values of the external temperature sensor 20 and of the front brightness sensor 32. The evaluation module 23 transmits, taking into account these linked measured values, an output signal whose value is a measure for the contrast K.

The signals produced from the linking of the measured values of the dirt sensor 26, of the rain sensor 31, and of the external temperature sensor 20 are fed via the evaluation module 23 to the processor 17, which feeds a signal corresponding to the transmission to the addition element 22. Likewise, the output signals of the evaluation module 36, which are determined from the linking of the measured values of the range of visibility sensor 27, of the external temperature sensor 20, and of the rain sensor 31, are fed to the function 17, which produces from them a signal characterizing the damping in the field of measurement, which is also fed to the additional element 22. There the function 17 links the output signal of the evaluation 36 with the output signals coming from the evaluation functions 37 and 38, said output signals characterizing the distance I to the object 3 and the velocity v of the vehicle.

The output signal of the addition element 22 is fed together with the signal produced by the evaluation 37 and characterizing the distance I from the object 3 is fed to a multiplier/amplifier 44. The influencing factor lies in the range from 0 to 1. The influencing factor is multiplied in the multiplier 44 by the output value of the addition element 22. That means the output value of the addition element 22 can only be reduced. If, for example, a following object or vehicle approaches, e. g. in fog or a very bright light, the brightness of the lights must be reduced. Otherwise, the approaching driver would be blinded. The output signal 45 of the multiplier 44 is fed to a further multiplier/amplifier 46, which in addition receives a signal 47 characterizing the contrast, said signal being formed from a linking of the measured values of the brightness sensor 13, of the external sensor 20, and the front brightness sensor 32. The contrast value K lies between 0 and ∞. The multiplier 46 forms, taking into account the output signal 45 of the multiplier 44 and the contrast signal 47, an output signal 48 with which the brightness of the corresponding lights 18 of the tail light is adjusted. The output signal 48 is limited, depending on the legal requirements and the light characteristics, by a limiting function 51 to be between a minimum and a maximum value. If the external visibility conditions are very poor, then the value of the output signal 48 lies at least near to the maximum value while with good external visibility conditions this value lies near to the minimum value. Consequently, it is ensured by the device that the light sources of the tail light are always supplied with current only to the extent that the tail light and thus the motor vehicle can be recognized by the other motorists and the legal requirements with respect to minimum and maximum permissible values are adhered to.

Advantageously, the output signal 48 can be linked with a correction factor 49 in order to ensure an optimal light adaptation in various variants of vehicles. In this case, the output signal 48 and the correction signal 49 are fed to a further multiplier/amplifier 50 which produces from these two signals the control signal 52 for the processor 17. The control signal 52 is transmitted by the processor 16 via the bus line 15. The control of the light source can, for example, be done via a pulse-width modulation control.

The device takes into account in the manner described external influences such as range of visibility, brightness, rain, external temperature, and motor vehicle-specific values such as the velocity or the steering angle. Through the described linking of these various influencing variables the brightness of the light of the tail light can be adapted optimally to the particular conditions. Thereby it is reliably ensured that the tail light and thus the motor vehicle are well recognizable for all conditions of visibility.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1-21. (canceled)

22. A light intensity adjusting assembly for a light source of a motor vehicle, said light intensity adjusting assembly comprising:
a processor for processing electrical signals;
a first sensor for detecting a first ambient condition, said first sensor creating a first sensor signal to be transmitted to said processor; and
a second sensor for detecting a second ambient condition and to create a second sensor signal to be transmitted to said processor such that said processor controls the light intensity of the light source based on said first and second sensor signals.

23. A light intensity adjusting assembly as set forth in claim 22 wherein said first sensor detects ambient light.

24. A light intensity adjusting assembly as set forth in claim 23 wherein said second sensor includes a sensing source for creating a test signal to be received by said second sensor to measure dissipation of the test signal.

25. A light intensity adjusting assembly as set forth in claim 24 wherein said second sensor includes a receiver for receiving the test signal generated by said sensing light source.

26. A light intensity adjusting assembly as set forth in claim 25 wherein said sensing source is a laser.

27. A light intensity adjusting assembly as set forth in claim 23 wherein said second sensor includes a velocity sensor for sensing the velocity of the motor vehicle.

28. A light intensity adjusting assembly as set forth in claim 23 wherein said second sensor includes a measuring sensor for measuring a distance between the motor vehicle and an object therebehind.

29. A light intensity adjusting assembly as set forth in claim 23 wherein said second sensor includes an ultrasonic sensor to ultrasonically detect an object behind the motor vehicle.

30. A light intensity adjusting assembly as set forth in claim 23 wherein said second sensor is a rain sensor.

31. A light intensity adjusting assembly as set forth in claim 23 wherein said second sensor is a steering sensor for detecting a steering angle of the motor vehicle.

32. A light intensity adjusting assembly as set forth in claim 23 wherein said second sensor is a visibility sensor for detecting the visibility of atmosphere behind the motor vehicle.
